(19) United States
(12) Patent Application Publication
(10) Pub. No.: US 2005/0020131 A1
(43) Pub. Date: Jan. 27, 2005

(54) Sealing device for an electrical terminal

(76) Inventors: Karl Beck, Langen (DE); Gregor Panitz, Wiesbaden (DE); Heinrich Schmidt, Langen (DE)

Correspondence Address: BARLEY SNYDER, LLC, 1000 WESTLAKES DRIVE, SUITE 275, BERWYN, PA, 19312, US

(21) Appl. No.: 10/863,614

(22) Filed: Jun. 8, 2004

(30) Foreign Application Priority Data
Jun. 11, 2003 (DE) 103 26 318.7

(51) Int. Cl. H01R 13/52

(52) U.S. Cl. 439/587

(57) ABSTRACT

The invention relates to a sealing device 1 for an electrical terminal 24 of a conductor carried in a carrier 21 which is electrically connected to a contact element 22 via the terminal 24. The sealing device comprises a housing having two housing parts 2, the two housing parts 2 being foldable at one end via a pivoting connection 4 to seal the terminal 24. The two housing parts 2 are respectively constructed as plate-shaped covers with large-area seals 3 on the inner faces of the covers.

### FIELD OF THE INVENTION

The invention relates to a sealing device for an electrical terminal on a flexible cable disposed in a connector housing.

### BACKGROUND OF THE INVENTION

Electrical conductors, arranged in a flat foil cable referred to as an ‘FFC-foil’ (flexible flat cable), are used in a wide variety of applications to transmit power and/or signals to and from various electrical components within an electrical system. Typically, a connector is provided at an end of the cable, with contacts attached to terminals formed at the ends of the conductors. In an exemplary application, the connector comprises a housing with two housing parts, pivotally connected to one another at one end of the connector via a pivoting connection with the housing parts opposing one another like a clamshell. In certain applications, such as automotive electrical systems, it is important to seal the connector against water to protect the electrical terminals disposed between the contacts and conductors. Existing connector housings are provided with circular seals such as annular face seals. To seal the terminals, which for example may be constructed as crimped connections, the two housing parts are brought together and folded against one another on the FFC-foil, which is arranged between the housing parts. In the folded position the annular face seals are fixed so that the terminals are surrounded by the circular seals of the two housing parts and the space enclosed by the housing parts is sealed against water.

Generally the housing further comprises a receptacle, sealed against the two housing parts, and into which the contact elements can be inserted. Thus, a plug connection between the contact elements of the connector and complementary contact elements of a mating connector can be created via a plug provided with the complementary contact elements, which can be inserted into the receptacle.

In the known sealing devices, however, the creation of an effective seal of the terminals against water requires a relatively high contact pressure of the seals on the cable, requiring considerable force when folding the housing parts. The sealing devices therefore typically have screw connections to facilitate the folding of the housing parts, whereby the construction of a sealing device becomes complicated and attaching the sealing device to a carrier becomes awkward. The need for a screw connection is a particular disadvantage where space is limited at the assembly position of the sealing device.

Other sealing devices are known in which the housing parts are folding and drawn together to create a space surrounding the cable in the region of the terminals, then sealed against water with adhesives or resins. However, as these adhesives subsequently still have to cure, attaching such sealing devices can, as a whole, be relatively time-consuming.

### SUMMARY OF THE INVENTION

The present invention provides a sealing device that has a simple construction and facilitates a secure seal of a terminal of a conductor carried on a flexible cable with quick and easy handling.

In an exemplary embodiment of the invention, a sealing device is provided for an electrical terminal of a conductor carried in a carrier which is electrically connected to a contact element via the terminal. The sealing device comprises a housing having two housing parts, the two housing parts being foldable at one end via a pivoting connection to seal the terminal. The two housing parts are respectively constructed as plate-shaped covers with large-area seals on the inner faces of the covers. When the housing parts are brought together on the carrier in the region of the terminals a watertight seal of the space enclosed by the housing parts and thus the terminals is provided by the large-area seals, whereby a secure seal of the terminal is achieved.

### BRIEF DESCRIPTION OF THE DRAWINGS

The invention will be disclosed in more detail below with reference to the accompanying drawings, in which:

FIG. 1 is a perspective view of a plug connector arrangement having a sealing device according to an embodiment of the invention;

FIGS. 2 to 4 are side views showing sequential steps for attaching the sealing device to a conductor carrier; and

FIG. 5 is a side sectional view of the sealing device attached to the conductor carrier with a mating plug inserted to form an electrical connection.

### DETAILED DESCRIPTION OF THE INVENTION

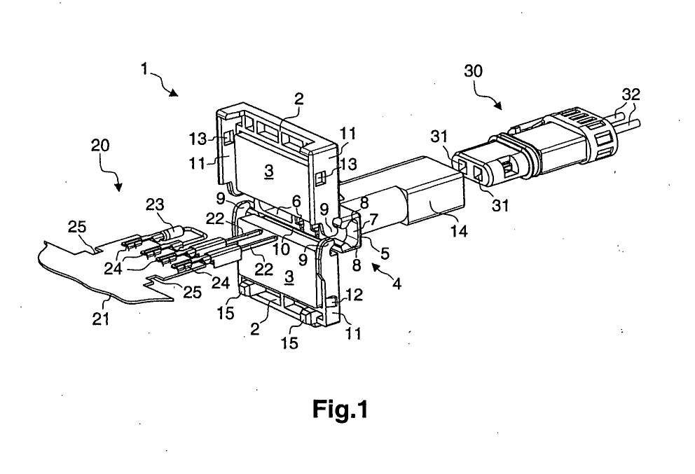

FIG. 1 shows a perspective view of a plug connector 30, a sealing device 1 according to an embodiment of the invention and a conductor carrier in the form of a flat foil cable 20. The flat foil cable 20 comprises a foil 21 within which a plurality of flat conductors (not shown in the figures) are arranged. The foil 21 acts as a carrier which also seals the conductors against water.

In the region of the flat foil cable 20 shown in FIG. 1, the flat foil cable 20 has four terminals 24, by which two conductors are electrically connected to contact elements constructed as contact pins 22, and two further conductors are electrically connected to a diode 23.

The terminals 24 shown in FIG. 1 are constructed as crimp connections which form an electrical connection with the conductors of the flat foil cable 20, with the aid of crimp sleeves which penetrate the foil 21 and enclose the conductors. Alternatively the conductors of the flat foil cable 20 can also be contacted via differently constructed terminals, such as for example piercing connections.

The sealing device 1 securely seals the terminals 24 of the flat foil cable 20 against water. The sealing device 1 comprises a housing with two housing parts 2, which are foldably connected to one another at one end via a pivoting connection 4. The two housing parts 2 are constructed respectively as plate-shaped covers with large-area seals 3 on the inner faces of the covers. In an exemplary embodiment of the invention, the large-area seals are formed by self-adhesive gel cushions 3. When the housing parts 2 are brought together on the flat foil cable 20 arranged between the housing parts 2 in the region of the terminals 24, the self-adhesive gel cushions adhere to each other and to the flat foil cable 20 to provide a watertight seal of the space enclosed by the housing parts 2 and thus the terminals 24. Furthermore, folding the housing parts 2 only requires a small force as the gel cushions 3 consist of a very flexible, formable and flowable material.

In the region of the terminals 24 of the flat foil cable 20, shown in FIG. 1, the width of the housing parts 2 of the sealing device 1 is greater than the width of the foil 21. As a result the gel cushions 3 of the folded housing parts 2 touch one another at the sides of the foil 21 and thus adhere to one another, whereby the foil 21 is enclosed by the gel cushions 3 and the seal of the terminals 24 is further improved.

Side walls 11 extend from the edges of the housing parts 2 adjoining the pivoting connection 4. The gel cushions 3 are arranged between the side wall 11. These side walls 11 grip one another in the form of a box when the housing parts 2 are folded, whereby an encapsulation of the flat foil cable 20 is produced and the sealed terminals 24 are additionally protected.

As shown in FIG. 1, the side walls 11 are provided with corresponding latching lugs 12 and recesses 13 to engage the folded housing parts 2 with one another. As a result the housing parts 2 are durably affixed to one another, and thus, a reliable seal of the terminals 24 is achieved.

One of the two housing parts 2 additionally comprises two pins 15 on the inner face which engage in recesses 25 on the sides of the foil 21 when the housing parts 2 are folded to fix the sealing device 1 onto the flat foil cable 20. As a result, a strain relief device is produced so that when a pulling force acts on the sealing device 1 no tensile force is exerted on the terminals 24 but is absorbed by the foil 21 via the recesses 25.

The pivoting connection 4 of the sealing device 1 comprises a web 5 with a plurality of apertures 6, allowing the pivoting connection 4 to be pushed onto the contact pins 22 and the diode 23 on the flat foil cable 20. The two housing parts 2 are pivotally hinged on the web 5 via natural hinges 10.

The web 5 is of substantially U-shaped construction in cross-section with a receiving aperture 7 comprising two recesses 8. When the housing parts 2 are folded, correspondingly formed curved hooks 9, which are arranged on the ends of the side walls 11 facing the web 5, engage in this receiving aperture 7. As a result, the folded housing parts 2 are additionally engaged with the web 5, whereby the affixing of the housing parts 2 is further improved.

Adjacent to the web 5, the housing of the sealing device 1 comprises a receptacle 14 into which the contact pins 22 are inserted before the housing parts 2 are folded. With the aid of latching elements not shown in the figures, the contact pins 22 are thus engaged with the receptacle 14. The receptacle 14 is further configured to receive the mating plug connector 30 which is provided with complementary contact bushings 31. In this manner the sealing device 1 acts as a socket connector into which the plug connector 30 is inserted to create electrical connections between the complementary contact pins 22 and contact bushings 31. As FIG. 1 shows the contact bushings 31 are further connected to conductors in cables 32.

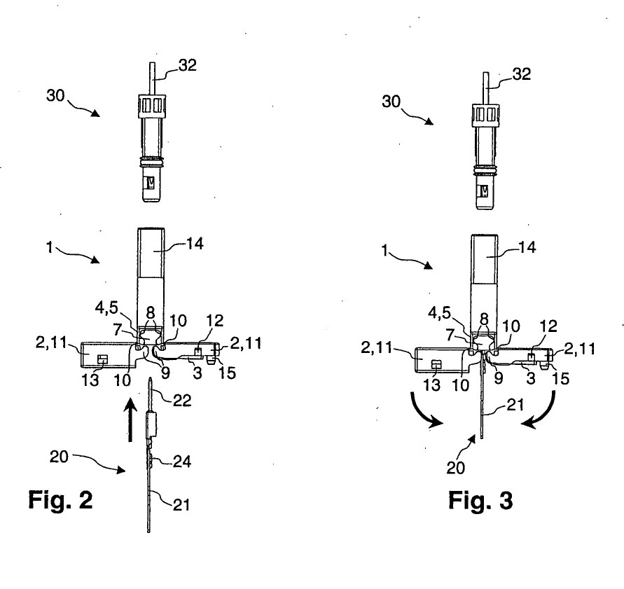

The following FIGS. 2 to 4 illustrate the process of attaching the sealing device 1 to the flat foil conductor 20. With reference to FIG. 2, the substantially U-shaped cross-section of the web 5 of the pivoting connection 4 is clearly visible. As indicated by the arrow in FIG. 2, the flat foil cable 20 is inserted between the housing parts 2 which are in an open position (i.e., not pivoted together).

As FIG. 3 shows, the sealing device 1 is then positioned on the flat foil cable 20 in such a manner that the contact pins 22 are inserted through the web 5 into the receptacle 14. Subsequently the housing parts 2 are folded as indicated by the arrows in FIG. 3, so that the side walls 11 of the housing parts 2 engage with one another in the form of a box, as shown in FIG. 4. In addition to the encapsulation of the terminals 24 of the flat foil cable 20 thereby produced, a compact space-saving geometry of the sealing device 1 simultaneously results. With reference to FIG. 4, it is further clearly visible that the curved hooks 9 of the side walls 11 engage in the recesses 8 of the receiving aperture 7 of the web 5 and thereby engage the folded housing parts 2 with the web 5.

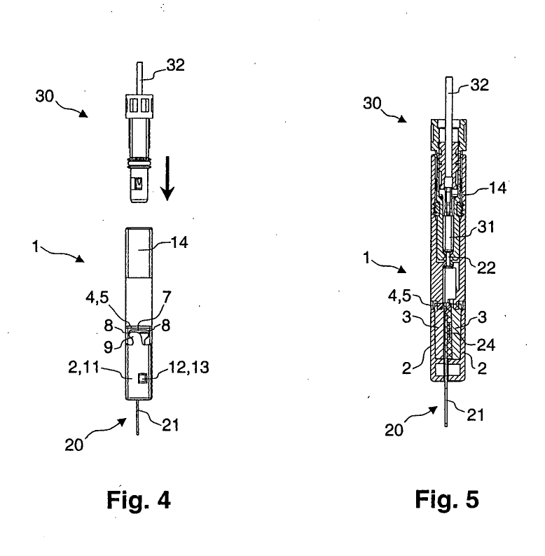

FIG. 5 shows a side sectional view of the sealing device 1 attached to the flat foil cable 20 with the mating plug connector 30 inserted into the receptacle 14. In this arrangement an electrical connection is created between the conductors of the flat foil cable 20 and the cables 32 connected to the mating plug connector 30 via the complementary contact pins 22 and contact bushings 31. As shown in FIG. 5, the self-adhesive gel cushions 3 seal the space enclosed by the housing parts 2 and thus the terminals 24. The terminals 24 are thus also sealed against the receptacle 14 of the sealing device 1. To improve this seal, the gel cushions 3 may be partially pressed into the receptacle 14 when the housing parts 2 are folded. This is achieved, for example, by the inner faces of the covers of the housing parts 2 being provided with a chamfer not shown in FIG. 5.

The sealing device 1 shown in the figures comprises self-adhesive gel cushions 3 as large-area seals. Alternative embodiments are contemplated in which gel cushions are used which are provided with a non-adhesive coating on the surfaces facing the flat foil conductor. As a result, increased contact pressure of the gel cushions on the flat foil conductor requires application of a greater force when the housing parts are folded to achieve a correspondingly secure seal, as the coating slightly reduces the yielding of the gel cushions. Higher contact pressure could be produced, for example, with the aid of additional ribs on the inner faces of the covers of the housing parts, exerting additional compression force of the gel cushions. The use of coated gel cushions has the advantage, however, that these gel cushions, in contrast to the non-coated gel cushions, do not have to be protected against dust and dirt by costly packaging when the sealing device is transported. Similarly, this accordingly applies to the use of other large-area, flexible seals which do not consist of gel.

The use of the sealing device according to the invention is not restricted to sealing terminals of a flat foil cable. Embodiments are contemplated which are configured to seal terminals of, for example, printed circuit boards or other carriers provided with conductors.

1. A sealing device for an electrical terminal electrically connecting a conductor carried in a carrier to a contact element, the sealing device comprising:
a housing having two housing parts, foldable at one end via a pivoting connection to seal the terminal, the two housing parts being respectively constructed as plate-shaped covers with large-area seals on the inner faces of the covers.

2. The sealing device according to claim 1, wherein the large-area seals comprise a flexible material.

3. The sealing device according to claim 1, wherein the pivoting connection comprises a web with an aperture formed therein, wherein the pivoting connection can be pushed onto the contact element on the carrier, the housing parts being hinged on the web by natural hinges.

4. The sealing device according to claim 3, wherein the web comprises a receiving aperture substantially U-shaped in cross-section, and on the ends facing the web the housing parts are provided with hook elements, which engage in correspondingly formed recesses in the receiving aperture of the web when the housing parts are folded.

5. The sealing device according to claim 1, wherein the large-area seals are formed by self-adhesive gel cushions.

6. The sealing device according to claim 5, wherein the surfaces of the gel cushions facing the carrier with the conductor are provided with a non-adhesive coating.

7. The sealing device according to claim 1, wherein the two housing parts comprise adjacent side walls on the pivoting connection which engage in one another in the form of a box when the housing parts are folded.

8. The sealing device according to claim 3, further comprising a receptacle provided adjacent to the web of the pivoting connection, into which the contact element can be inserted and which is configured to receive a mating plug connector comprising a complementary contact element to form an electrical connection between the contact element and the complementary contact element.

9. The sealing device according to claim 1, further comprising latching elements provided on the housing parts to engage the folded housing parts with one another.

10. The sealing device according to claim 1, further comprising strain relief elements configured to fix the sealing device on the carrier when the housing parts are folded.
